(19) United States
(12) Patent Application Publication
(10) Pub. No.: US 2024/0146089 A1
(43) Pub. Date: May 2, 2024

(54) STORAGE SYSTEM CONFIGURED FOR USE WITH AN ENERGY MANAGEMENT SYSTEM

(71) Applicant: Enphase Energy, Inc., Petaluma, CA (US)

(72) Inventors: Chris Morrow YOUNG, Round Rock, TX (US); Donald Richard ZIMMANCK, Sebastopol, CA (US)

(21) Appl. No.: 18/379,246

(22) Filed: Oct. 12, 2023

Related U.S. Application Data
(60) Provisional application No. 63/420,313, filed on Oct. 28, 2022.

(51) Int. Cl. H02J 7/06; H02J 7/00

(52) U.S. Cl. CPC H02J 7/06; H02J 7/0029

(57) ABSTRACT

A storage system configured for use with an energy management system is provided herein and comprises a rechargeable battery, a grid detection circuit operably connected to the rechargeable battery such that when an AC power source is not detected by the grid detection circuit and a voltage at the rechargeable battery falls below a threshold voltage, the grid detection circuit places the rechargeable battery into a sleep mode, and a switch operably connected to the grid detection circuit and configured to override the grid detection circuit so that rechargeable battery exits the sleep mode until a voltage at the rechargeable battery is equal to or greater than a predetermined voltage.

### CROSS-REFERENCE TO RELATED APPLICATIONS

The present application claims the benefit of and priority to U.S. Provisional Application Ser. No. 63/420,313, filed on Oct. 28, 2022, the entire contents of which is incorporated herein by reference.

### BACKGROUND

### 1. Field of the Disclosure

Embodiments of the present disclosure generally relate to power systems and, more particularly, to methods and apparatus for AC coupled battery deep discharge recovery.

### 2. Description of the Related Art

Conventional storage systems comprise AC coupled batteries which contain subsystems, e.g., such as battery management units, control systems, and telemetry that can consume energy. For example, when AC is not present, such as during an extended outage or when a storage system is not in use, the subsystems system can continue to draw power. Left unchecked, the subsystems can continue to draw power from the AC coupled batteries eventually depleting the AC coupled batteries and possibly damaging the AC coupled batteries. Accordingly, some storage systems have deep discharge protection modes that are configured to shut down the subsystems and place the AC coupled batteries into a lower power sleep mode.

For example, conventional deep discharge protection modes can use an AC presence as a recovery mechanism to guarantee that the AC batteries can recharge when the AC batteries are woken up. In some instances, however, such as when the energy management system comprises one or more generating assets that are not capable of creating a stable AC waveform (e.g., in a grid-tied solar system), then there is no way of waking up the AC batteries during an outage without applying AC from another source (e.g., a generator), which may not be readily available in a disaster situation.

Therefore, the inventors have found improved methods and apparatus for AC coupled battery deep discharge recovery.

### SUMMARY

In accordance with some aspects of the present disclosure, a storage system configured for use with an energy management system comprises a rechargeable battery, a grid detection circuit operably connected to the rechargeable battery such that when an AC power source is not detected by the grid detection circuit and a voltage at the rechargeable battery falls below a threshold voltage, the grid detection circuit places the rechargeable battery into a sleep mode, and a switch operably connected to the grid detection circuit and configured to override the grid detection circuit so that rechargeable battery exits the sleep mode until a voltage at the rechargeable battery is equal to or greater than a predetermined voltage.

In accordance with some aspects of the present disclosure, a method for managing a storage system configured for use with an energy management system comprises detecting if an AC power source is present on the storage system, detecting if a voltage at a rechargeable battery falls below a threshold voltage, placing the rechargeable battery into a sleep mode, and overriding the sleep mode until the voltage at the rechargeable battery is equal to or greater than a predetermined voltage.

In accordance with some aspects of the present disclosure, a non-transitory computer readable storage medium has instructions stored thereon that when executed by a processor perform a method for managing a storage system configured for use with an energy management system. The method comprises detecting if an AC power source is present on the storage system, detecting if a voltage at a rechargeable battery falls below a threshold voltage, placing the rechargeable battery into a sleep mode, and overriding the sleep mode until the voltage at the rechargeable battery is equal to or greater than a predetermined voltage.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only a typical embodiment of this disclosure and are therefore not to be considered limiting of its scope, for the disclosure may admit to other equally effective embodiments.

FIG. 1 is a block diagram of a system for power conversion, in accordance with at least some embodiments of the present disclosure;

FIG. 2 is a block diagram of an AC battery system, in accordance with at least some embodiments of the present disclosure;

FIG. 3 is a schematic of grid detection circuit configured for use with the AC battery system of FIG. 2, in accordance with at least one embodiment of the present disclosure;

FIG. 4 is a schematic of a DC protection circuit configured for use with the grid detection circuit of FIG. 3, in accordance with at least one embodiment of the present disclosure; and

FIG. 5 is a flowchart of a method for managing a storage system configured for use with an energy management system, in accordance with at least one embodiment of the present disclosure.

### DETAILED DESCRIPTION

In accordance with the present disclosure, methods and apparatus for AC coupled battery deep discharge recovery are provided herein. For example, apparatus described herein can comprise one or more switches connected between a grid detection circuit and a DC protection circuit. The one or more switches are configured to override the grid detection circuit to exit a sleep mode until a voltage of a battery is equal to or greater than a predetermined voltage. Thus, in situations where AC systems contain generating assets that are not capable of creating a stable AC waveform, e.g., such as grid-tied solar systems, batteries are not capable of charging/discharging during an outage without applying AC from another source, such as a generator, which may not be readily available in an emergency (e.g., a disaster situation). The one or more switches allow the DC protection circuit to manually override the grid detection circuit during an emergency for activating a battery management unit to wake up the battery.

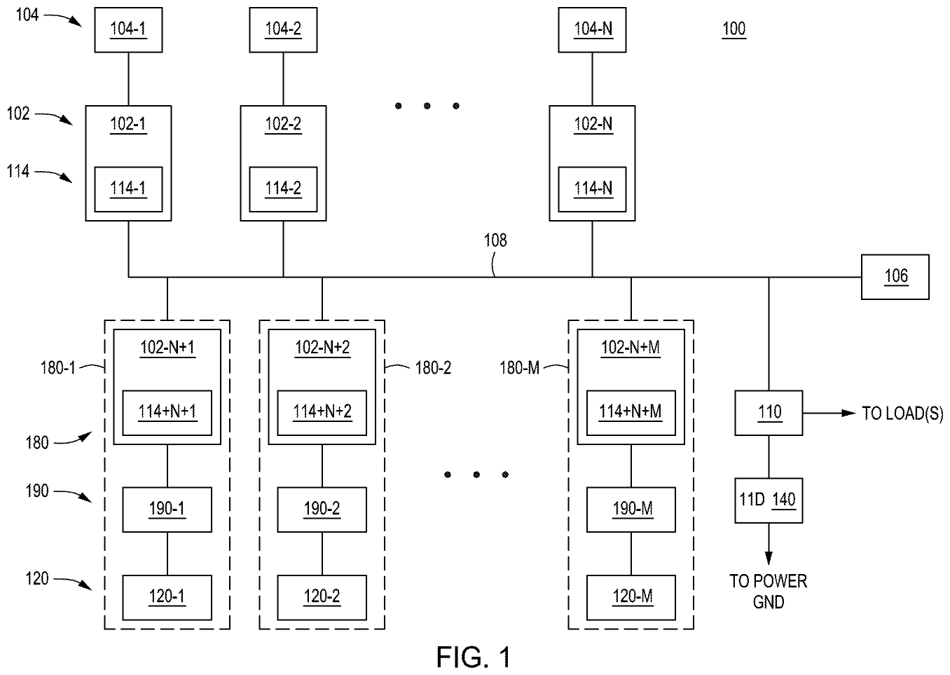

FIG. 1 is a block diagram of a system 100 (energy management system) for power conversion using one or more embodiments of the present disclosure. This diagram only portrays one variation of the myriad of possible system configurations and devices that may utilize the present disclosure.

The system 100 is a microgrid that can operate in both an islanded state and in a grid-connected state (i.e., when connected to another power grid (such as one or more other microgrids and/or a commercial power grid). The system 100 comprises a plurality of power converters 102-1, 102-2, . . . 102-N, 102-N+1, and 102-N+M collectively referred to as power converters 102 (which also may be called power conditioners); a plurality of DC power sources 104-1, 104-2, . . . 104-N, collectively referred to as power sources 104 (e.g., resources); a plurality of energy storage devices/delivery devices 120-1, 120-2, . . . 120-M collectively referred to as energy storage/delivery devices 120; a system controller 106; a plurality of BMUs 190-1, 190-2, . . . 190-M (battery management units) collectively referred to as BMUs 190; a system controller 106; a bus 108; a load center 110; and an IID 140 (island interconnect device) (which may also be referred to as a microgrid interconnect device (MID)). In some embodiments, such as the embodiments described herein, the energy storage/delivery devices are rechargeable batteries (e.g., multi-C-rate collection of AC batteries) which may be referred to as batteries 120, although in other embodiments the energy storage/delivery devices may be any other suitable device for storing energy and providing the stored energy. Generally, each of the batteries 120 comprises a plurality cells that are coupled in series, e.g., eight cells coupled in series to form a battery 120.

Each power converter 102-1, 102-2 . . . 102-N is coupled to a DC power source 104-1, 104-2 . . . 104-N, respectively, in a one-to-one correspondence, although in some other embodiments multiple DC power sources may be coupled to one or more of the power converters 102. The power converters 102-N+1, 102-N+2 . . . 102-N+M are respectively coupled to plurality of energy storage devices/delivery devices 120-1, 120-2 . . . 120-M via BMUs 190-1, 190-2 . . . 190-M to form AC batteries 180-1, 180-2 . . . 180-M, respectively. Each of the power converters 102-1, 102-2 . . . 102-N+M comprises a corresponding controller 114-1, 114-2 . . . 114-N+M (collectively referred to as the inverter controllers 114) for controlling operation of the power converters 102-1, 102-2 . . . 102-N+M.

In some embodiments, such as the embodiment described below, the DC power sources 104 are DC power sources and the power converters 102 are bidirectional inverters such that the power converters 102-1 . . . 102-N convert DC power from the DC power sources 104 to grid-compliant AC power that is coupled to the bus 108, and the power converters 102-N+1 . . . 102-N+M convert (during energy storage device discharge) DC power from the batteries 120 to grid-compliant AC power that is coupled to the bus 108 and also convert (during energy storage device charging) AC power from the bus 108 to DC output that is stored in the batteries 120 for subsequent use. The DC power sources 104 may be any suitable DC source, such as an output from a previous power conversion stage, a battery, a renewable energy source (e.g., a solar panel or photovoltaic (PV) module, a wind turbine, a hydroelectric system, or similar renewable energy source), or the like, for providing DC power. In other embodiments the power converters 102 may be other types of converters (such as DC-DC converters), and the bus 108 is a DC power bus.

The power converters 102 are coupled to the system controller 106 via the bus 108 (which also may be referred to as an AC line or a grid). The system controller 106 generally comprises a CPU coupled to each of support circuits and a memory that comprises a system control module for controlling some operational aspects of the system 100 and/or monitoring the system 100 (e.g., issuing certain command and control instructions to one or more of the power converters 102, collecting data related to the performance of the power converters 102, and the like). The system controller 106 is capable of communicating with the power converters 102 by wireless and/or wired communication (e.g., power line communication) for providing certain operative control and/or monitoring of the power converters 102.

In some embodiments, the system controller 106 may be a gateway that receives data (e.g., performance data) from the power converters 102 and communicates (e.g., via the Internet) the data and/or other information to a remote device or system, such as a master controller (not shown). Additionally or alternatively, the gateway may receive information from a remote device or system (not shown) and may communicate the information to the power converters 102 and/or use the information to generate control commands that are issued to the power converters 102.

The power converters 102 are coupled to the load center 110 via the bus 108, and the load center 110 is coupled to the power grid via the IID 140. When coupled to the power grid (e.g., a commercial grid or a larger microgrid) via the IID 140, the system 100 may be referred to as grid-connected; when disconnected from the power grid via the IID 140, the system 100 may be referred to as islanded. The IID 140 determines when to disconnect from/connect to the power grid (e.g., the IID 140 may detect a grid fluctuation, disturbance, outage or the like) and performs the disconnection/connection. Once disconnected from the power grid, the system 100 can continue to generate power as an intentional island, without imposing safety risks on any line workers that may be working on the grid, using the droop control techniques described herein. The IID 140 comprises a disconnect component (e.g., a disconnect relay) for physically disconnecting/connecting the system 100 from/to the power grid. In some embodiments, the IID 140 may additionally comprise an autoformer for coupling the system 100 to a split-phase load that may have a misbalance in it with some neutral current. In certain embodiments, the system controller 106 comprises the IID 140 or a portion of the IID 140.

The power converters 102 convert the DC power from the DC power sources 104 and discharging batteries 120 to grid-compliant AC power and couple the generated output power to the load center 110 via the bus 108. The power is then distributed to one or more loads (for example to one or more appliances) and/or to the power grid (when connected to the power grid). Additionally or alternatively, the generated energy may be stored for later use, for example using batteries, heated water, hydro pumping, H₂O-to-hydrogen conversion, or the like. Generally, the system 100 is coupled to the commercial power grid, although in some embodiments the system 100 is completely separate from the commercial grid and operates as an independent microgrid.

In some embodiments, the AC power generated by the power converters 102 is single-phase AC power. In other embodiments, the power converters 102 generate three-phase AC power.

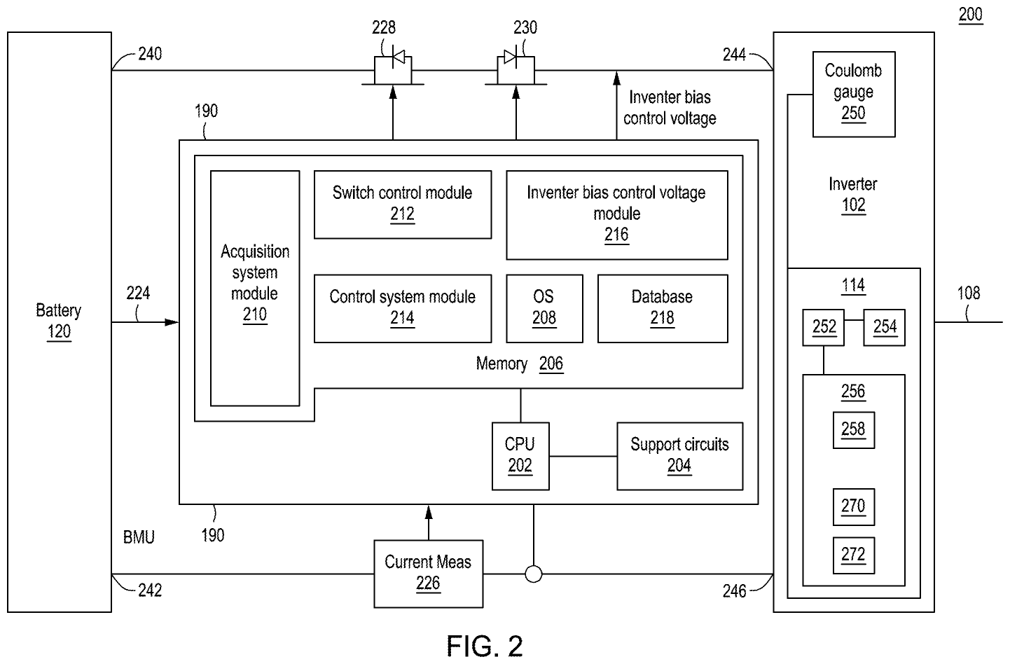

A storage system configured for use with an energy management system, such as the Enphase® Energy System, is described herein. For example, FIG. 2 is a block diagram of an AC battery system 200 (e.g., a storage system) in accordance with one or more embodiments of the present disclosure.

The AC battery system 200 comprises a BMU 190 coupled to a battery (e.g., the battery 120) and one or more inverters (e.g., the power converters 102). In at least some embodiments, the battery 120 can comprise a plurality of cells (not shown) and the power converters 102 can comprise four embedded converters (e.g., four embedded microinverters). In at least some embodiments, the battery 120 can be the IQ Battery 3 (or the IQ Battery 10) and the microinverters can be the IQ8X-BAT microinverters, both available from Enphase®. A pair of metal—oxide— semiconductor field-effect transistors (MOSFETs) switches—switches 228 and 230—are coupled in series between a first terminal 240 of the battery 120 and a first terminal of the inverter 144 such the body diode cathode terminal of the switch 228 is coupled to the first terminal 240 of the battery 120 and the body diode cathode terminal of the switch 230 is coupled to the first terminal 244 of the power converter 102. The gate terminals of the switches 228 and 230 are coupled to the BMU 190.

A second terminal 242 of the battery 120 is coupled to a second terminal 246 of the power converter 102 via a current measurement module 226 which measures the current flowing between the battery 120 and the power converter 102.

The BMU 190 is coupled to the current measurement module 226 for receiving information on the measured current, and also receives an input 224 from the battery 120 indicating the battery cell voltage and temperature. The BMU 190 is coupled to the gate terminals of each of the switches 228 and 230 for driving the switch 228 to control battery discharge and driving the switch 230 to control battery charge as described herein. The BMU 190 is also coupled across the first terminal 244 and the second terminal 246 for providing an inverter bias control voltage (which may also be referred to as a bias control voltage) to the inverter 102 as described further below.

The configuration of the body diodes of the switches 228 and 230 allows current to be blocked in one direction but not the other depending on state of each of the switches 228 and 230. When the switch 228 is active (i.e., on) while the switch 230 is inactive (i.e., off), battery discharge is enabled to allow current to flow from the battery 120 to the power converter 102 through the body diode of the switch 230. When the switch 228 is inactive while the switch 230 is active, battery charge is enabled to allow current flow from the power converter 102 to the battery 120 through the body diode of the switch 228. When both switches 228 and 230 are active, the system is in a normal mode where the battery 120 can be charged or discharged.

The BMU 190 comprises support circuits 204 and a memory 206 (e.g., non-transitory computer readable storage medium), each coupled to a CPU 202 (central processing unit). The CPU 202 may comprise one or more processors, microprocessors, microcontrollers and combinations thereof configured to execute non-transitory software instructions to perform various tasks in accordance with embodiments of the present disclosure. The CPU 202 may additionally or alternatively include one or more application specific integrated circuits (ASICs). In some embodiments, the CPU 202 may be a microcontroller comprising internal memory for storing controller firmware that, when executed, provides the controller functionality described herein. The BMU 190 may be implemented using a general purpose computer that, when executing particular software, becomes a specific purpose computer for performing various embodiments of the present disclosure.

The support circuits 204 are well known circuits used to promote functionality of the CPU 202. Such circuits include, but are not limited to, a cache, power supplies, clock circuits, buses, input/output (I/O) circuits, and the like. The BMU 190 may be implemented using a general purpose computer that, when executing particular software, becomes a specific purpose computer for performing various embodiments of the present disclosure. In one or more embodiments, the CPU 202 may be a microcontroller comprising internal memory for storing controller firmware that, when executed, provides the controller functionality described herein.

The memory 206 may comprise random access memory, read only memory, removable disk memory, flash memory, and various combinations of these types of memory. The memory 206 is sometimes referred to as main memory and may, in part, be used as cache memory or buffer memory. The memory 206 generally stores the OS 208 (operating system), if necessary, of the inverter controller 114 that can be supported by the CPU capabilities. In some embodiments, the OS 208 may be one of a number of commercially available operating systems such as, but not limited to, LINUX, Real-Time Operating System (RTOS), and the like.

The memory 206 stores non-transitory processor-executable instructions and/or data that may be executed by and/or used by the CPU 202 to perform, for example, one or more methods for discharge protection, as described in greater detail below. These processor-executable instructions may comprise firmware, software, and the like, or some combination thereof. The memory 206 stores various forms of application software, such as an acquisition system module 210, a switch control module 212, a control system module 214, and an inverter bias control module 216. The memory 206 additionally stores a database 218 for storing data related to the operation of the BMU 190 and/or the present disclosure, such as one or more thresholds, equations, formulas, curves, and/or algorithms for the control techniques described herein. In various embodiments, one or more of the acquisition system module 210, the switch control module 212, the control system module 214, the inverter bias control module 216, and the database 218, or portions thereof, are implemented in software, firmware, hardware, or a combination thereof.

The acquisition system module 210 obtains the cell voltage and temperature information from the battery 120 via the input 224, obtains the current measurements provided by the current measurement module 226, and provides the cell voltage, cell temperature, and measured current information to the control system module 214 for use as described herein.

The switch control module 212 drives the switches 228 and 230 as determined by the control system module 214. The control system module 214 provides various battery management functions, including protection functions (e.g., overcurrent (OC) protection, overtemperature (OT) protection, and hardware fault protection), metrology functions (e.g., averaging measured battery cell voltage and battery current over, for example, 100 ms to reject 50 and 60 Hz ripple), state of charge (SoC) analysis (e.g., coulomb gauge 250 for determining current flow and utilizing the current flow in estimating the battery SoC; synchronizing estimated SOC values to battery voltages (such as setting SoC to an upper bound, such as 100%, at maximum battery voltage; setting SoC to a lower bound, such as 0%, at a minimum battery voltage); turning off SoC if the power converter 102 never drives the battery 120 to these limits; and the like), balancing (e.g., autonomously balancing the charge across all cells of a battery to be equal, which may be done at the end of charge, at the end of discharge, or in some embodiments both at the end of charge and the end of discharge). By establishing upper and lower estimated SoC bounds based on battery end of charge and end of discharge, respectively, and tracking the current flow and cell voltage (i.e., battery voltage) between these events, the BMU 190 determines the estimated SoC.

Continuing with reference to FIG. 2, the inverter controller 114 comprises support circuits 254 and a memory 256, each coupled to a CPU 252 (central processing unit). The CPU 252 may comprise one or more processors, microprocessors, microcontrollers and combinations thereof configured to execute non-transient software instructions to perform various tasks in accordance with embodiments of the present disclosure. The CPU 252 may additionally or alternatively include one or more application specific integrated circuits (ASICs). In some embodiments, the CPU 252 may be a microcontroller comprising internal memory for storing controller firmware that, when executed, provides the controller functionality herein. The inverter controller 114 may be implemented using a general purpose computer that, when executing particular software, becomes a specific purpose computer for performing various embodiments of the present disclosure.

The support circuits 254 are well known circuits used to promote functionality of the CPU 252. Such circuits include, but are not limited to, a cache, power supplies, clock circuits, buses, input/output (I/O) circuits, and the like. The inverter controller 114 may be implemented using a general purpose computer that, when executing particular software, becomes a specific purpose computer for performing various embodiments of the present disclosure. In one or more embodiments, the CPU 252 may be a microcontroller comprising internal memory for storing controller firmware that, when executed, provides the controller functionality described herein.

The memory 256 may comprise random access memory, read only memory, removable disk memory, flash memory, and various combinations of these types of memory. The memory 256 is sometimes referred to as main memory and may, in part, be used as cache memory or buffer memory. The memory 256 generally stores the OS 258 (operating system), if necessary, of the inverter controller 114 that can be supported by the CPU capabilities. In some embodiments, the OS 258 may be one of a number of commercially available operating systems such as, but not limited to, LINUX, Real-Time Operating System (RTOS), and the like.

The memory 256 stores non-transient processor-executable instructions and/or data that may be executed by and/or used by the CPU 252. These processor-executable instructions may comprise firmware, software, and the like, or some combination thereof. The memory 256 stores various forms of application software, such as a power conversion control module 270 for controlling the bidirectional power conversion, and a battery management control module 272.

The BMU 190 communicates with the system controller 106 to perform balancing of the batteries 120 (e.g., multi-C-rate collection of AC batteries) based on a time remaining before each of the batteries are depleted of charge, to perform droop control (semi-passive) which allows the batteries to run out of charge at substantially the same time, and perform control of the batteries to charge batteries having less time remaining before depletion using batteries having more time remaining before depletion, as described in greater detail below.

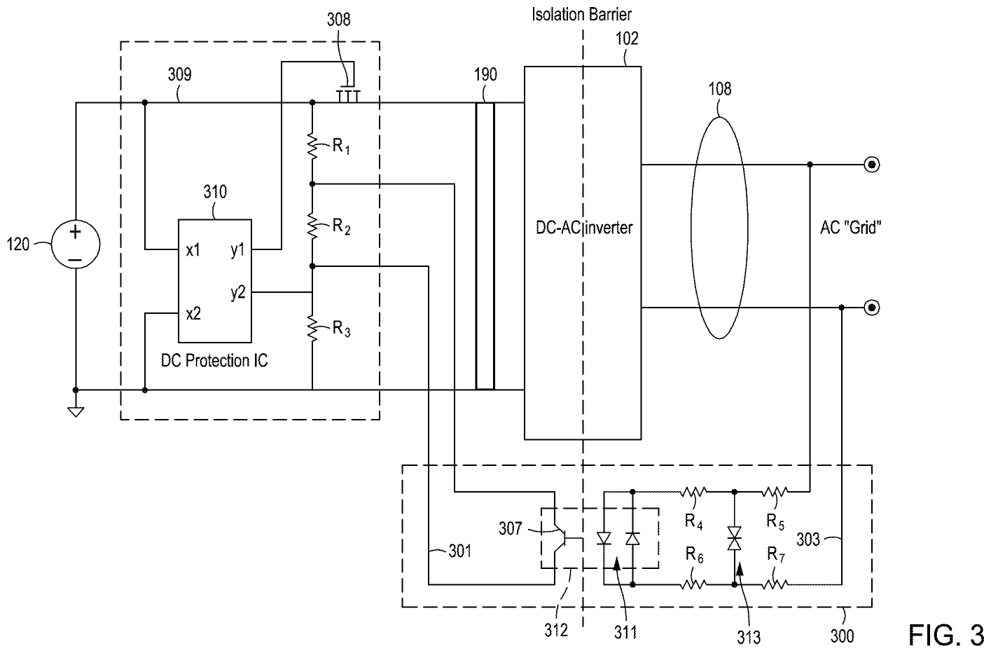

FIG. 3 is a schematic of grid detection circuit 300 configured for use with the AC battery system 200 of FIG. 2, in accordance with at least one embodiment of the present disclosure.

The grid detection circuit 300 comprises an input side 301 that is configured to connect between a DC power source (e.g., the battery 120) and a battery management unit (BMU), e.g., the BMU 190, of the AC battery system 200. The grid detection circuit 300 also comprises an output side 303 that is configured to connect between an output side of an inverter (e.g., the power converter 102) and an AC power source (e.g., the bus 108 that can connect to one of a grid or a photovoltaic, etc.). In at least some embodiments, the inverter can be a DC-AC inverter or other type of inverter capable of performing operations described herein.

The input side 301 comprises a transistor 307 that connects to a voltage divider network of a DC protection circuit 309 connected to the DC power source. The DC protection circuit 309 comprises an IC 310 having an X₁ pin and an X₂ pin that are connected across the DC power source. The IC 310 also comprises a Y₁ pin (e.g., ground) and an Y₂ pin that are respectively connected to one or more MOSFETS 308 (n-type or p-type), which connects to the BMU 190, and the voltage divider network, which can include three resistors R₁ to R₃ connected in series with each other. In at least some embodiments, the output-collector of the transistor 307 connects between the resistors R₁ and R₂ and the output-emitter of the transistor 307 connects between resistors the R₂ and R₃.

Continuing with reference to FIG. 3, the output side 303 of the grid detection circuit 300 comprises at least one photo diode, at least one Zennor diode, and a plurality of resistors connected in parallel to each other and the at least one photo diode and the at least one Zennor diode. In at least some embodiments, two photodiodes 311 are connected parallel to each other and opposite the base of the transistor 307. Additionally, a pair of Zennor diodes 313 are connected in series with each other and parallel to each of the two photodiodes 311, and the resistors R₄ to R₇ connected parallel to each other and the two photodiodes 311 and the pair of Zennor diodes 313, with the resistors R₅ and R₇ connected to the bus 108.

The two photodiodes 311 on the output side of the grid detection circuit 300 and the transistor 307 on the input side of the grid detection circuit 300 form an optocoupler 312. In use, the grid detection circuit 300 develops a rectified dc voltage from the ac line voltage. The magnitude of the dc voltage is sensed by a downstream trigger circuitry (e.g., DC protection circuit 309) to determine when to bias the two photodiodes 311. Due to the rectification stage upstream of the optocoupler 312, the two photodiodes 311 are biased with a dc current.

In accordance with the present disclosure, the grid detection circuit 300 is connected to the DC protection circuit for determining when the battery management unit (BMU) operates within the under-voltage-lockout (UVLO) at or above the first charge threshold and when the battery management unit (BMU) operates within the under-voltage-lockout (UVLO) at or above the second charge threshold.

In at least some embodiments, the BMU 190 can function as a cell level monitor and software running in the power converter 102 CPU, both of which can be powered off the power converter 102 housekeeping power supply, which can be powered downstream of the transistor coupled to pin Y1 of 310. Thus, when the Y₂ pin goes below the UVLO threshold of the IC 310, the housekeeping supply is disconnected from the battery 120 completely putting it into sleep mode. In the sleep mode, there is no CPU running, e.g., everything is OFF, and the only power draw from the battery 120 is from the IC 310 and the resistor network comprised of the resistors R₁, R₂, and R₃, which is designed to draw just μA of current. Accordingly, the only way to wake up the system is for the voltage on the Y₂ pin to rise above the UVLO threshold of the IC 310, which occurs when the grid detection circuit 300, which is analog, shorts out the resistor R₂.

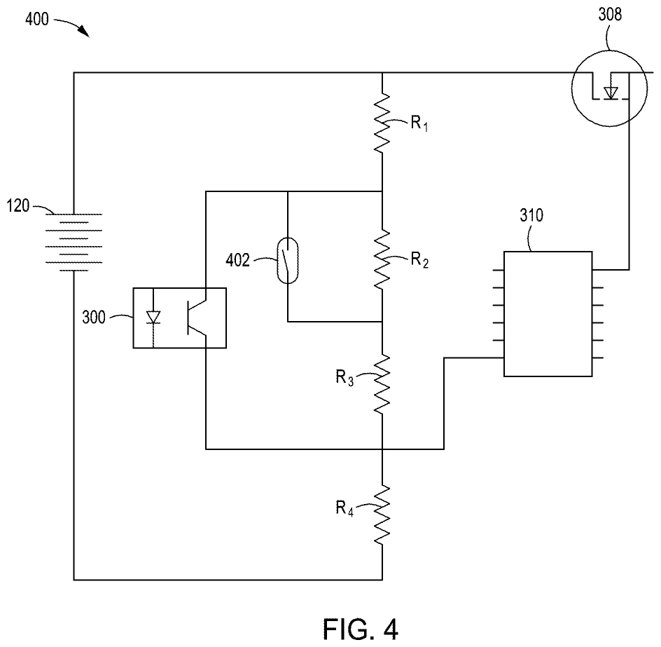

FIG. 4 is a schematic of a DC protection circuit 400 configured for use with the grid detection circuit 300 of FIG. 3, in accordance with at least one embodiment of the present disclosure.

For example, one or more switches 402 (e.g., magnetic reed switches, push button switches, slide switches, toggle switches, etc.) can be added to the voltage divider network (e.g., resistors R₁ to R₃) that feeds an under-voltage pin (e.g., X₁) of the IC 310. In at least some embodiments, the one or more switches 402 can be implemented as a magnetic reed switch that can be activated using a permanent magnet through an enclosure of the AC battery system 200. In at least some embodiments, the one or more switches 402 may be disposed across a resistor (e.g., a resistor R₄) other than the resistors R₁ to R₃ that the grid detection circuit 300 is connected to. In such embodiments, a different min recovery voltage threshold from the grid detection circuit 300 can be provided, which allows the grid detection circuit 300 to wake-up the AC battery system if a battery voltage is above a recoverable level (e.g., about 2V per cell), whereas the manual over-ride may is configured to wake-up the AC battery system if the battery voltage is high enough (e.g., about 2.5V per cell) to reliably black start an unloaded system for long enough to wake up other resources, such as inverters, controllers, load managers, communication modules, etc.

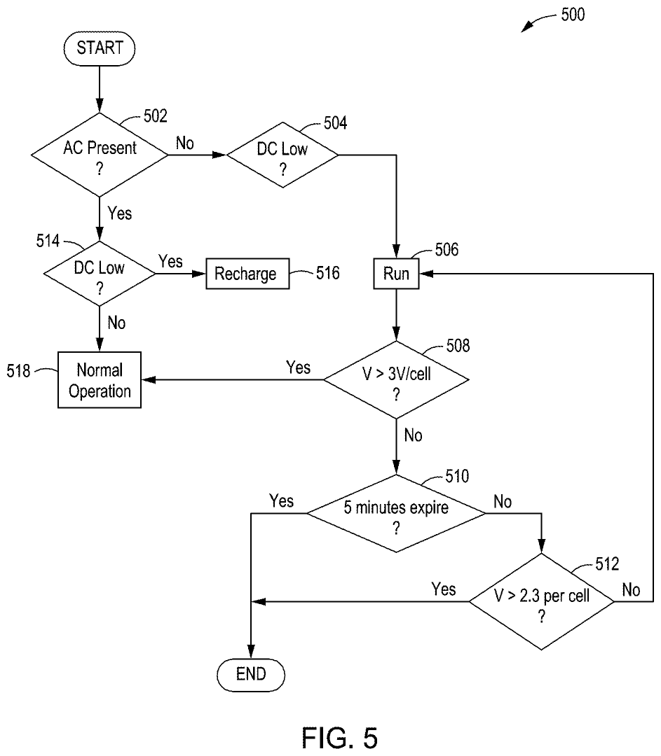

FIG. 5 is a flowchart of a method 500 for managing the batteries 120 (e.g., a storage system) configured for use with the system 100, in accordance with at least one embodiment of the present disclosure. For example, the methods described herein allow operation of the AC battery system 200 during override operation (e.g., override the sleep mode) and allows the AC battery system 200 to bootup with a relatively low DC voltage and no AC present (e.g., using the manual magnetic reed switch).

For example, at 502, the method 500 comprises detecting if AC is present. For example, the BMU 190 is configured to detect if AC is present (e.g., if a grid is detected). Next, if no at 502, at 504, the BMU 190 detects if DC at the battery 120 is at a predetermined voltage (e.g., DC is relatively low (under-voltage), a first threshold voltage of about 2.5V per cell). If yes at 504, at 506, the system is allowed to run in override operation (e.g., the battery can be charged via the power converter 102). For example, in at least some embodiments, the system is allowed to run for a few minutes (e.g., as long as the voltage stays above ˜2.5V per cell). Any generating assets that are AC coupled can take a few minutes to start charging the battery 120.

Next, at 508, the BMU 190 detects if the voltage at the battery is at a predetermined voltage (e.g., greater than or equal to about 3V per cell). In at least some embodiments, the predetermined voltage can be less than or greater than 3V per cell.

If no at 508, at 510, it is determined if a predetermined time has expired, e.g., continue override operation for up to 5 minutes. In at least some embodiments, the predetermined time can be less than or greater than 5 minutes. If yes at 510, the override operation is discontinued and the AC battery system returns to normal operation. Conversely, if no at 510, at 512 it is determined if the voltage at the battery is at a predetermined voltage (e.g., less than or equal to 2.3V per cell). For example, as noted above, in embodiments, it may prove advantageous to have a different min recovery voltage threshold from the grid detection circuit 300, which allows the grid detection circuit 300 to wake-up the AC battery system if a battery voltage is above a recoverable level, e.g., about 2V per cell. In at least some embodiments, the predetermined voltage can be greater than 2.5V per cell. Again, if yes at 512, the override operation is discontinued. When an over-ride is asserted, the AC battery system is given about a 5 minute window to get the battery cells to at least 3 V/cell before the inverter shuts down to keep what is left of the charge. In at least some embodiments, additional logic/circuitry can be used to override the timer if the cells are detected charging. Conversely, if no at 512, 506-512 is repeated so that the override operation can continue until the voltage at the battery is equal to or greater than 3V per cell or the predetermined time has expired. As there is no guarantee that there are devices available to charge the battery when the over-ride is asserted, the secondary threshold at 512 protects a battery from damage, e.g., an over-ride is commanded when there is more load than generation on the AC battery system and the batteries are not capable of charging.

Additionally, if yes at 502, at 514, the BMU 190 detects if DC is at a predetermined voltage (e.g., DC is relatively low, less than about 3V per cell), as described with respect to 504. If yes at 514, at 516, the AC battery system is allowed to charge the battery (e.g., the battery can be charged via the grid) under normal operation, as described above. If no at 514, at 518, the AC battery system is allowed to operate under normal operation, as described above.

While the foregoing is directed to embodiments of the present disclosure, other and further embodiments of the disclosure may be devised without departing from the basic scope thereof, and the scope thereof is determined by the claims that follow.

1. A storage system configured for use with an energy management system, comprising:
a rechargeable battery;
a grid detection circuit operably connected to the rechargeable battery such that when an AC power source is not detected by the grid detection circuit and a voltage at the rechargeable battery falls below a threshold voltage, the grid detection circuit places the rechargeable battery into a sleep mode; and
a switch operably connected to the grid detection circuit and configured to override the grid detection circuit so that the rechargeable battery exits the sleep mode until a voltage at the rechargeable battery is equal to or greater than a predetermined voltage.

2. The storage system of claim 1, wherein the switch is a magnetic reed switch.

3. The storage system of claim 1, wherein the switch is connected across at least one resistor of a DC protection circuit or a resistor that is not part of the DC protection circuit.

4. The storage system of claim 1, wherein the grid detection circuit is configured to wake-up the rechargeable battery if the voltage at the rechargeable battery is above a first recoverable level and the switch is configured to wake-up the rechargeable battery if the voltage at rechargeable battery is above a second recoverable level different from the first recoverable level.

5. The storage system of claim 4, wherein the first recoverable level is about 2V per cell and the second recoverable level is about 3V per cell.

6. The storage system of claim 1, wherein the switch is configured to override the grid detection circuit for about 5 minutes.

7. The storage system of claim 1, wherein the switch is connected to an under-voltage pin of an IC of a DC protection circuit.

8. A method for managing a storage system configured for use with an energy management system, comprising:
detecting if an AC power source is present on the storage system;
detecting if a voltage at a rechargeable battery falls below a threshold voltage;
placing the rechargeable battery into a sleep mode; and
overriding the sleep mode until the voltage at the rechargeable battery is equal to or greater than a predetermined voltage.

9. The method of claim 8, wherein overriding the sleep mode comprises using a switch, and wherein the switch is connected to an under-voltage pin of an IC of a DC protection circuit.

10. The method of claim 9, wherein the switch is a magnetic reed switch.

11. The method of claim 9, wherein the switch is connected across at least one resistor of a DC protection circuit or a resistor that is not part of the DC protection circuit.

12. The method of claim 9, wherein placing the rechargeable battery into the sleep mode comprising using a grid detection circuit that is configured to wake-up the rechargeable battery if the voltage at the rechargeable battery is above a first recoverable level and the switch is configured to wake-up the rechargeable battery if the voltage at rechargeable battery is above a second recoverable level different from the first recoverable level.

13. The method of claim 12, wherein the first recoverable level is about 2V per cell and the second recoverable level is about 3V per cell.

14. The method of claim 8, wherein overriding the sleep mode is performed for about 5 minutes.

15. The method of claim 8, wherein if the AC power source is present on the storage system and the voltage at the rechargeable battery falls below the threshold voltage, further comprising charging the rechargeable battery.

16. The method of claim 8, wherein if the AC power source is present on the storage system and the voltage at the rechargeable battery does not fall below the threshold voltage, further comprising operating the storage system under normal operation.

17. A non-transitory computer readable storage medium having instructions stored thereon that when executed by a processor perform a method for managing a storage system configured for use with an energy management system, comprising:
detecting if an AC power source is present on the storage system;
detecting if a voltage at a rechargeable battery falls below a threshold voltage;
placing the rechargeable battery into a sleep mode; and
overriding the sleep mode until the voltage at the rechargeable battery is equal to or greater than a predetermined voltage.

18. The non-transitory computer readable storage medium of claim 17, wherein overriding the sleep mode comprises using a switch, and wherein the switch is connected to an under-voltage pin of an IC of a DC protection circuit.

19. The non-transitory computer readable storage medium of claim 18, wherein the switch is a magnetic reed switch.

20. The non-transitory computer readable storage medium of claim 18, wherein the switch is connected across at least one resistor of a DC protection circuit or a resistor that is not part of the DC protection circuit.
